(19) United States
(12) Patent Application Publication
(10) Pub. No.: US 2006/0093094 A1
(43) Pub. Date: May 4, 2006

(54) Automatic measurement and announcement voice quality testing system

(76) Inventors: Zhu Xing, Singapore (SG); Dennis Sh Goh, Singapore (SG); Edwin Lim Chong Jen, Singapore (SG)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/966,252

(22) Filed: Oct. 15, 2004

(51) Int. Cl. H04M 1/24; H04M 3/08

(52) U.S. Cl. 379/1.02; 370/352

(57) ABSTRACT

An Automatic Measurement and Announcement Voice Quality Tester (“AMA-VQT”) measures the voice quality of a communication link from a customer premises equipment (“CPE”) through a Network under Test to the AMA-VQT. The AMA-VQT may include a Communication Module in signal communication with the CPE through the Network under Test, an Authorization Module in signal communication with the Communication Module, an Instruction Announcement and DTMF Input Recognition Module in signal communication with the Communication Module and Authorization Module, a Voice Composing and Announcement Module in signal communication with the Communication Module and a Voice Quality Measurement Module in signal communication with the Authorization Module, Instruction Announcement and DTMF Input Recognition Module, and Voice Composing and Announcement Module, where the Voice Quality Measurement Module is adapted to measure the voice quality of the communication link.

### BACKGROUND OF THE INVENTION

The worldwide utilization of telecommunication systems is growing and adapting at a rapid pace. As a result, telephone service providers are continuously attempting to improve the quality of the voice communications that are carried on their telecommunication networks. These telecommunication networks are typically known as public switched telephone networks (“PSTNs”).

With the advent of modem digital communication systems, many of these telephone service providers are utilizing digital communication techniques to communicate voice signals and data signals across their PSTNs. As an example of a typical PSTN operation, a user telephone at a customer premises (such as the user's home or office) may be connected to the PSTN. The telephone, which is typically known as customer premises equipment (“CPE”), may transmit an analog voice signal, or signals, generated from the speech of the user at the CPE. The PSTN may then convert the analog voice signal to a digital data signal that is transmitted through the numerous components of the PSTN before being converted back into a second analog voice signal that is transmitted to a second CPE at another customer premises.

Typically, PSTNs rely on the use of circuit-switched connections that assign distinct lines or “circuits” to each connected call. When a CPE connects to the PSTN (i.e., goes off-hook), the local central office of the telephone service provider provides a dial tone to the CPE and assigns it a “circuit.” Once a desired number has been dialed by the CPE, the call is switched to one or more intermediary central offices within the PSTN before it is connected to its final destination.

Modem digital communication systems have also given rise to numerous types of computer networks such as Ethernets and the Internet. As a result, a new telephone technology has arisen that is fundamentally different from the original PSTNs. This new telephone technology supports bursty non-real-time applications such as e-mail and file data transfers through numerous types of protocols including the file transfer protocol (“ftp”).

Generally known as Voice over Network (“VoN”), or Voice over Packet (“VoP”), this new technology relies on packet-oriented digital networks delivering voice communication services as a digital stream. By sampling speech and recording it in digital form, encoding the digitized speech into packets, and transmitting the packets across different computer networks, VoN systems offer a lower cost alternative to the original PSTNs due to their inherent efficiencies and lower bandwidth requirements.

At present, the most popular example of VoP is the Voice over Internet Protocol (“VoIP” or “Voice over IP”) services that utilize the Internet Protocol (“IP”). Additional examples include voice over frame relay (“VoFR”), voice over asynchronous transfer mode (“VoATM”), voice over digital subscriber line (“VoDSL”), and voice over cable (“VoCable”).

As a result, many companies are starting to use VoIP networks within their internal communication systems and these VoIP networks connect through a VoIP gateway to the PSTNs. Additionally, to improve the data performance of their networks, many telephone service providers are upgrading their PSTN networks to utilize VoN techniques for greater efficiency in their backbones (i.e., networks). These new PSTN networks may be referred to as hybrid VoN-PSTN networks.

Unfortunately, VoN techniques have made maintaining voice quality at high levels more complex because the VoN systems typically compress the voice signal and transmit it in discrete packets. This is a problem because voice traffic generally needs timely packet delivery and VoN techniques were originally employed on computer networks that were not originally designed for these conditions. As a result, transmission conditions that pose little threat to non-real-time data traffic may introduce severe problems to real-time packetized voice traffic. These conditions include real-time message delivery, gateway processes, packet loss, packet delay, and the utilization of nonlinear codecs.

Generally, voice quality is subjective, but typically includes three important parameters: (1) signal clarity; (2) transmission delays; and (3) signal echoes. While the impact of voice quality is subjective in nature, objective measurement techniques for each of these parameters have been developed. The clarity of a voice signal is generally described by how accurately the received signal reproduces the signal that was transmitted. Typically, signal fidelity, lack of distortion, and intelligibility are important elements in the description of its clarity. Delay is the time that it takes to transmit a voice signal from the speaker to the listener, and echo is the sound of the speaker's voice that he hears returning to him. Delay and echo may be annoyances and distractions to the user. A lack of clarity may also degrade the ability of the user to obtain information from the interchange and heighten the level of frustration.

Since users have become accustomed to traditional PSTN levels of voice quality and compare the voice quality of other services to that typically obtained from a PSTN, for VoP services to be acceptable they must maintain or improve on this level of quality. Voice quality is now an important differentiating factor for VoP networks and equipment. Consequently, measuring voice quality in a relatively inexpensive, reliable, and objective way has become very important.

Specialized test equipment for the PSTNs is well known and available from a number of providers. The test equipment ranges from simple hand-held testers for service technicians to sophisticated testers for automated network management. These testers are intended to enable telephone technicians to verify the proper operation and quality of voice communication on the PSTN and to track down faults.

Remote telephone test units, also known as responders, provide added flexibility to the testing of telephone lines and equipment by providing calibrated reference signals and by measuring and detecting received signals. These responders are designed primarily for performing tests over circuit-switched connections.

A Voice Quality Tester (“VQT”) is a device that measures various parameters of a phone call to quantify the impairments created by the telephone network. The measurement set is specifically designed to analyze packet based telephony networks or telephony networks that include packet based networks. These measurements include clarity, delay, echo, and signal loss.

As an example, FIG. 1 shows an existing voice quality measurement system 100 utilized to test the connection between two VQTs (VQT₁ 102 and VQT₂ 104) through a Network under Test 106. The measurement process begins by establishing a call between VQT₁ 102 and VQT₂ 104. Different signaling methods may be utilized to establish the call, depending on the interface in use. Once the call is established and the media path is active, a measurement can be selected and configured to analyze the call path through the Network under Test 106. For most measurements, a WAV file, or files representing speech, noise, or tone, are transmitted over the Network under Test 106, and then received and processed by the VQT₂ 104 with the results subsequently displayed at either VQT₂ 104, VQT₁ 102, or both. Existing professional VQT systems may provide numerous different measurement results such as different voice quality score (e.g., PESQ, PSQM, R-factor), network signal loss, network delay, echo, VAD, etc. All these measurement results are helpful to professional users to understand the voice quality of the Network under Test 106 and do trouble shooting.

An example of VQT₁ 102 and/or VQT₂ 104 may include the Agilent Technologies Telegra®, Model R-VQT J1981A, which measures objective speech quality and other communication parameters including delay, echo and Dual Tone Multiple Frequency (“DTMF”) performance.

Several products are available for testing traditional telephone apparatus that are used for connection to the PSTN; however, PSTN testers are not suitable for VoIP devices because they cannot be used for troubleshooting subscriber or network equipment that is connected to VoN or hybrid VoN-PSTN networks.

The VoN industry has developed a number of test standards for measuring the quality of voice communication across packet-based networks. These test standards include the International Telecommunication Union (“ITU”) Perceptual Speech Quality Measure (“PSQM”), as described in ITU-T Recommendation P.861, titled “Objective quality measurement of telephone-band (300-3400 Hz) speech codecs,” Perceptual Evaluation of Speech Quality (“PESQ”), as described in ITU-T Recommendation P.862, titled “Perceptual evaluation of speech quality (”PESQ”): An objective method for end-to-end speech quality assessment of narrow-band telephone networks and speech codecs,” the MOS-LQO described by ITU-T Recommendation P.800.1, titled “Mean Opinion Score (MOS) terminology,” ITU-T Recommendation P.563, titled, “Single ended method for objective speech quality assessment in narrow-band telephony applications,” and the R-Factor described by ITU-T Recommendation G.107, titled “The E-model, a computational model for use in transmission planning,” which objectively measure audio quality and are incorporated herein by reference.

VoN testers, such as the Agilent Telegra®, R-VQT J1981A, perform voice quality measurements by playing a standard coded speech file into a VoN connection and recording and analyzing the received speech file at the other end of the connection.

Unfortunately, existing VQT systems are typically too complex for users that are not voice quality test engineers and/or technicians, such as field engineers of a telecommunication company, information technology (“IT”) support engineers of normal enterprise or small IP telephone service providers, and normal telephone line users. These types of users may only desire to know the voice quality in simple terms at a time of their choosing. However, with current VQT devices, users may only obtain voice quality data from a typically expensive VQT service provider or from actually purchasing an expensive VQT monitoring system. If the users acquire a VQT monitoring system, they will also need to employ specially trained professional people to monitor the voice quality. Thus, current VQT devices do not allow users to determine the voice quality of their lines simply and immediately by themselves. Therefore, a need exists for a voice quality testing system that allows normal customers (i.e., users) to determine the quality of the line they are using cheaply, conveniently and quickly at any time.

### SUMMARY

An automatic measurement and announcement voice quality tester (“AMA-VQT”) and method are shown for measuring the voice quality of a communication link from a customer premises equipment (“CPE”) through a Network under Test to the AMA-VQT. The AMA-VQT is capable of establishing a communication link between itself and the CPE, determining the type of service requested from the CPE, and transmitting instructions to the CPE corresponding to the level of service requested. Additionally, the AMA-VQT is capable of receiving voice quality test data from the CPE in response to the transmitted instructions, measuring the received voice quality test data, determining a voice quality score from the received voice quality test data, and transmitting the voice quality score to the CPE.

As an example of implementation of the AMA-VQT, the AMA-VQT may include a Communication Module in signal communication with the CPE through the Network under Test, an Authorization Module in signal communication with the Communication Module, and an Instruction Announcement and DTMF Input Recognition Module in signal communication with the Communication Module and Authorization Module. The AMA-VQT may also include a Voice Composing and Announcement Module in signal communication with the Communication Module and a Voice Quality Measurement Module in signal communication with the Authorization Module, Instruction Announcement and DTMF Input Recognition Module, and Voice Composing and Announcement Module, where the Voice Quality Measurement Module is capable of measuring the voice quality of the communication link from the CPE through a Network under Test to the AMA-VQT.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a block diagram of an existing voice quality measurement system utilized to test the connection between two Voice Quality Testers (“VQTs”) through a Network under Test.

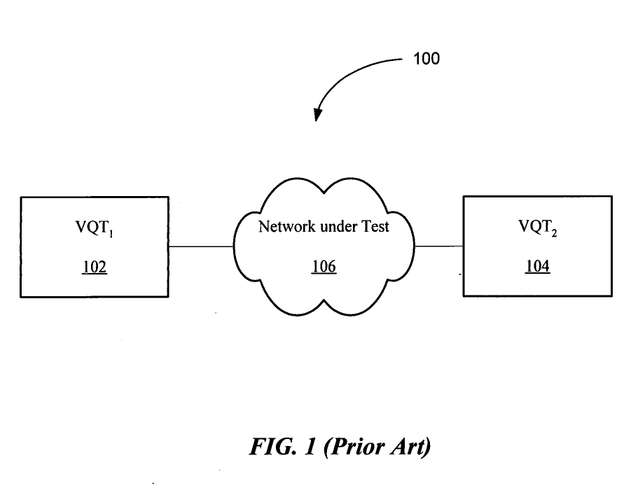

FIG. 2 is a block diagram of an example of an implementation of an Automatic Measurement and Announcement Voice Quality Test System utilized to test the connection between a customer premises equipment (“CPE”) and at least one AMA-VQT through a Network under Test in accordance with the present invention.

FIG. 3 is a block diagram of an example of an implementation of the AMA-VQT shown in FIG. 2 in accordance with the present invention.

FIG. 4 is a flowchart illustrating a process preformed by the AMA-VQT in measuring the voice quality through the Network under Test shown in FIG. 3 in accordance with the present invention.

### DETAILED DESCRIPTION

In the following description, reference is made to the accompanying drawings that form a part hereof, and which show, by way of illustration, a specific embodiment in which the invention may be practiced. Other embodiments may be utilized and structural changes may be made without departing from the scope of the present invention.

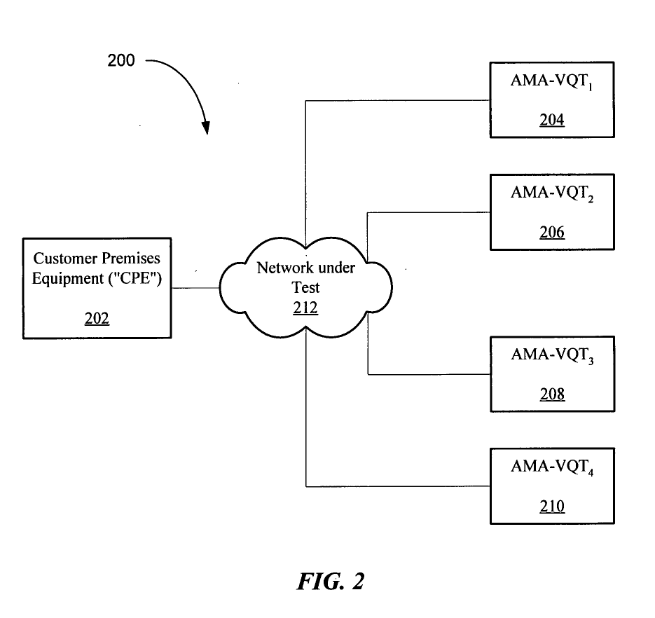

FIG. 2 is a block diagram of an example of an implementation of an Automatic Measurement and Announcement Voice Quality Test System 200 in accordance with the present invention. The Automatic Measurement and Announcement Voice Quality Test System 200 may include a customer premises equipment (“CPE”) 202 and four Automatic Measurement and Announcement Voice Quality Testers (“AMA-VQTs”), such as AMA-VQT₁ 204, AMA-VQT₂ 206, AMA-VQT₃ 208 and AMA-VQT₄ 210, in signal communication with a Network under Test 212. The Automatic Measurement and Announcement Voice Quality Test System 200 may be utilized to establish a communication link between the CPE 202 and at least one AMA-VQT through the Network under Test 212, and then test the connection between the CPE 202 and the at least one AMA-VQT. Those skilled in the art will appreciate that while only four AMA-VQTs have been shown for illustration purposes, the Automatic Measurement and Announcement Voice Quality Test System 200 may equally include from one AMA-VQT to as many as needed without departing from the scope of the invention. Similarly, while only one CPE 202 has been shown for illustration purposes, the Automatic Measurement and Announcement Voice Quality Test System 200 may equally include from one CPE to as many as needed without departing from the spirit of the invention.

The CPE 202 may be a standard telephone, Internet Protocol (“IP”) telephone, computer or other communication device. The CPE 202 may include an audio device such as a cassette playing device, compact disk (“CD”), Direct Video Disk (“DVD”) device, or memory device connected to an electronic sound device capable of playing MP3, WAVE, or other types of digital sound files or generated predetermined digital sounds.

Each AMA-VQT includes a Voice Quality Measurement module (not shown) that is capable of measuring the voice quality between the CPE 202 and the respective AMA-VQT through the Network under Test 212 and generating a voice quality score. Each AMA-VQT may be located anywhere in the world including the central office of a PSTN telephone service provider and/or the different offices of a company utilizing a company telephone system.

As an example, AMA-VQT₁ 204 may be located in New York, AMA-VQT₂ 206 may be located in London, AMA-VQT₃ 208 may be located in Tokyo and AMA-VQT₄ 210 may be located in Hong Kong. If the CPE 202 were located in Singapore, the CPE 202 may be used to individually test the respective voice quality from the CPE 202 through the Network under Test 212 to the AMA-VQT₁ 204 in New York, AMA-VQT₂ 206 in London, AMA-VQT₃ 208 in Tokyo and AMA-VQT₄ 210 in Hong Kong.

In operation, generally only one AMA-VQT is needed at any one location because the CPEs from any part of the world may call this AMA-VQT and receive a voice quality score for the connection between the respective CPE making the call and the AMA-VQT receiving the call. Additionally, the performance of these types of tests usually does not require a lot of time; therefore, a single AMA-VQT may support numerous tests per hour. As an example, if the test requires approximately one minute to complete, the AMA-VQT unit would be capable of supporting approximately 60 tests per hour.

The AMA-VQT is automated and responds directly to the requests of CPE and is capable of allowing users who are non-professional voice quality testers to know the voice quality of their respective calls by providing a voice quality score and by categorizing the voice quality as “excellent, good, fair, poor, or bad.” Additionally, the AMA-VQT may allow different users to determine the accuracy of the test in which they are interested. As an example, if a user selects a first level of service, the AMA-VQT may perform an entry level test. If the user selects a second level of service, the AMA-VQT may perform an advanced level test. If the user selects a third level of service, the AMA-VQT may perform a professional level test. Different levels of service may vary in the accuracy of the voice quality measurements and the utilized network resources.

Another example of operation supported by the AMA-VQT is an automatic scheduled test mode. Based on the needs of a CPE, the AMA-VQT may be programmed to automatically call the CPE in a scheduled fashion and perform the voice quality testing.

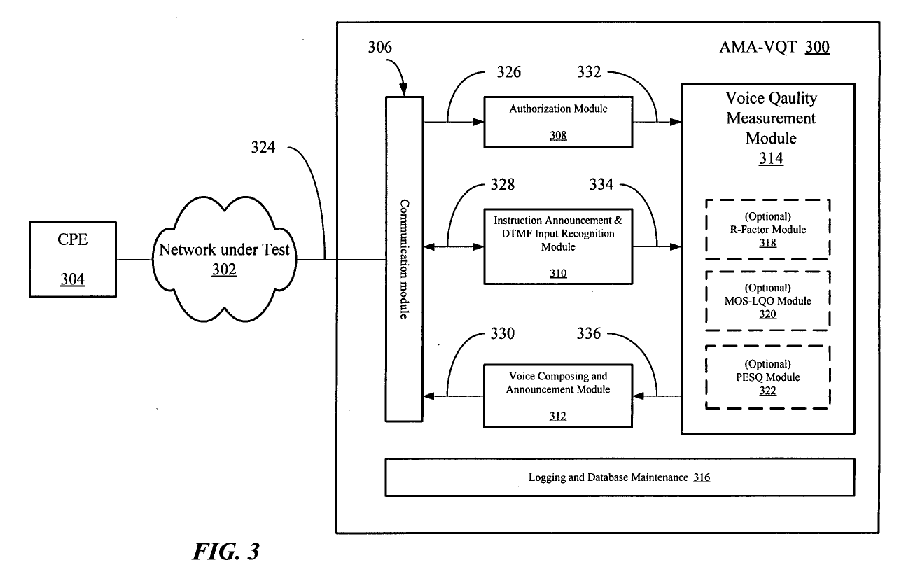

In FIG. 3, a block diagram of an AMA-VQT 300 is shown in signal communication with a Network under Test 302 and a CPE 304. The AMA-VQT 300 is an example of an implementation of each of the AMA-VQTs (i.e., AMA-VQT₁ 204, AMA-VQT₂ 206, AMA-VQT₃ 208 and AMA-VQT₄ 210) shown in FIG. 2 in accordance with the present invention and is capable of establishing a call with the CPE 304 through a Network under Test 302.

The AMA-VQT 300 may include a Communication Module 306, an Authorization Module 308, an Instruction Announcement and Dual Tone Multiple Frequency (“DTMF”) Input Recognition Module 310, a Voice Composing and Announcement Module 312, and a Voice Quality Measurement Module 314. The AMA-VQT 300 may also include a Logging and Database Maintenance Module 316.

The Voice Quality Measurement Module 314 may include different types of optional voice quality determination modules. The voice quality modules may include an R-Factor Module 318, MOS-LQO Module 320, and PESQ Module 322.

In this example of an implementation, the Communication Module 306 may be in signal communication with the CPE 304 through the Network under Test 302 via signal path 324. Additionally, the Communication Module 306 may be in signal communication with the Authorization Module 308, Instruction Announcement and DTMF Input Recognition Module 310, and Voice Composing and Announcement Module 312 via signal paths 326, 328 and 330, respectively. Additionally, the Voice Quality Measurement Module 314 may be in signal communication with the Authorization Module 308, Instruction Announcement and DTMF Input Recognition Module 310, and Voice Composing and Announcement Module 312 via signal paths 332, 334 and 336, respectively.

Again, the CPE 304 may be a standard telephone, IP telephone, computer or other communication device. The CPE 304 also may include any audio device such as a cassette playing device, CD, DVD, or memory device connected to an electronic sound device capable of playing MP3, WAVE, or other types of digital sound files or generated predetermined digital sounds.

The Communication Module 306 may be a communication device or subsystem that is configured for, adapted to and/or capable of establishing a communication link between the CPE 304 and the AMA-VQT 300 through the Network under Test 302. The Instruction Announcement and DTMF Input Recognition Module 310 may be a device or subsystem that is configured for, adapted to and/or capable of sending instructions to the CPE 304, receiving (i.e., including detecting) and decoding the DTMF (such as the tone corresponding to a “1” being selected on the CPE 304) signals from the CPE 304, and responding to the CPE 304 with corresponding commands. The Voice Composing and Announcement Module 312 may be a device or subsystem that is configured for, adapted to and/or capable of composing an announcement message of the testing results utilizing a prerecorded voice database (not shown) that may be played to the CPE 304. The announcement message is then sent to the Communication Module 306, which transmits it through signal path 324 and the Network under Test 302 to the CPE 304.

The Logging and Database Maintenance Module 316 is a module that is configured for, adapted to and/or capable of logging the data and maintaining the data in a memory (not shown) and/or database (not shown). The Logging and Database Maintenance Module 316 may also include software capable of controlling the AMA-VQT 300 through a controller module (not shown).

The Voice Quality Measurement Module 314 may be a device or subsystem that is configured for, adapted to and/or capable of measuring the voice quality of a received voice signal from the CPE 304 and calculates a voice quality score that corresponds to the voice quality from the CPE 304 through the Network under Test 302 to the AMA-VQT 300. The voice quality score may be determined by utilizing a service level module located either in the Voice Quality Measurement Module 314 or in signal communication with the Voice Quality Measurement Module 314. The Authorization Module 308 is configured for, adapted to and/or capable of determining the service level module to use based on the authorization data received from the CPE 304. The authorization data may include a password that is provided by the CPE 304.

As an example, the optional R-Factor Module 318 may be a service level module utilizing R-Factor to determine the score. The optional MOS-LQO Module 320 may be a service level module utilizing MOS-LQO to determine the score. The optional PESQ Module 322 may be a service level module utilizing PESQ to determine the score. The R-Factor, MOS-LQO and PESQ are standard tests for measuring the quality of voice communication across packet-based networks as defined by the International Telecommunication Union (“ITU”). The R-Factor Module 318, MOS-LQO Module 320, PESQ Module 322 are optional because additional standard tests may be used including PSQM, also defined by the ITU, and Perceptual Analysis Measurement System (“PAM”) developed by British Telecommunications without departing from the spirit of the invention.

PESQ stands for “Perceptual evaluation of speech quality” as described in ITU-T Recommendation P.862, titled “Perceptual evaluation of speech quality (PESQ), an objective method for end-to-end speech quality assessment of narrowband telephone networks and speech codecs.” MOS-LQO is a “Mean Opinion Score—Listening Quality Objective” described in ITU-T Recommendation P.800.1, titled “Mean Opinion Score (MOS) terminology,” and ITU-T Recommendation P.563, titled “Single Ended Method for Objective Speech Quality Assessment in Narrow-Band Telephony Applications.” The R-Factor stands for the “Rating Factor” that is produced by the E-model described by ITU-T Recommendation G.107, titled, “The E-model, a computational model for use in transmission planning.” Additionally, PSQM stands for the “Perceptual Speech Quality Measure,” as described in ITU-T Recommendation P.861, titled “Objective quality measurement of telephone-band (300-3400 Hz) speech codecs.” ITU-T recommendations G.107, P.563, P.800.1, P861 and P862 are all documents that describe objective measures of audio quality and are incorporated herein by reference.

As an example, if the CPE 304 selects a first level of service, the AMA-VQT 300 may perform an entry level test utilizing the R-Factor Module 318. If the user selects a second level of service, the AMA-VQT 300 may perform an advanced level test utilizing the MOS-LQO Module 320. If the user selects a third level of service, the AMA-VQT 300 may perform a professional level test utilizing the PESQ Module 322.

In the case of the first level of service, the voice quality measurement is based on the R-Factor of ITU-T Recommendation G.107. The R-Factor is derived with the E-Model and is based on the measurement of the telecommunication device's performance such as its delay, packet loss, etc. The R-Factor estimates the voice quality in the range of values 50-100 as described in Table 1.

TABLE 1
Voice quality vs. R-Factor Voice Quality Score

| User Satisfaction | Voice Quality Score |
|---|---|
| Very Satisfied | 90-100 |
| Satisfied | 80-89 |
| Some Users Dissatisfied | 70-79 |
| Many Users Dissatisfied | 60-69 |
| Nearly all Users Dissatisfied | 50-59 |

For this level of service, the CPE 304 sets up a call (i.e., a communication link) with the AMA-VQT 300. The R-Factor voice quality score is then determined and automatically announced back to the CPE 304.

In the case of the second level of service, the voice quality measurement is based on the MOS-LQO of ITU-T P.563 and P.800.1. According to P.563 and P.800.1, the MOS-LQO method estimates the voice quality score in the range of values 1-5 as described in Table 2.

TABLE 2
Voice quality vs. MOS-LQO Voice Quality Score

| Voice Quality | Voice Quality Score |
|---|---|
| Excellent | 5 |
| Good | 4 |
| Fair | 3 |
| Poor | 2 |
| Bad | 1 |

The voice quality score predicted by MOS-LQO is more accurate than the voice quality score predicted from the R-Factor because the voice quality score predicted by MOS-LQO is related to the perceived quality based on an actual transmitted voice signal or audio data signal. For this level of service, the CPE 304 sets up a call (i.e., a communication link) with the AMA-VQT 300, and the user of the CPE 304 either speaks some words into the CPE 304 or sends a pre-recorded voice signal according to the instructions from the AMA-VQT 300. The AMA-VQT 300 then determines the MOS-LQO voice quality score and it is automatically announced back to the CPE 304.

In the case of the third level of service, the voice quality measurement is based on PESQ of ITU-T Recommendation P.862. According to P.862, the PESQ method estimates the voice quality score in the range of values −0.5-4.5, as described in Table 3.

TABLE 3
Voice quality vs. PESQ Voice Quality Score

| Voice Quality | Voice Quality Score |
|---|---|
| Good | 4.0-4.5 |
| Fair | 3.0-3.9 |
| Poor | 1.0-2.9 |
| Bad | −0.5-0.9 |

The PESQ method is more accurate than either the R-Factor or the MOS-LQO methods because the PESQ is an enhanced perceptual quality measurement for voice quality in telecommunications. It is derived from comparing an original audio signal and a degraded audio signal after going through the network. Generally, the PESQ Module 322 may automatically play a reference audio signal file on one channel while simultaneously recording the audio signal received from the CPE 304 through the Network under Test 302. The PESQ Module 322 then compares the two audio signals and determines a PESQ voice quality score.

For the PESQ method the CPE 304 needs to have an audio device function such as a cassette playing function or digital audio playing function to set up the call (i.e., communication link) with the AMA-VQT 300 in order to play a pre-recorded audio signal for the AMA-VQT 300. Once the AMA-VQT 300 establishes a call with the CPE 304, the AMA-VQT 300 begins recording the audio signal played by the CPE 304. The audio signal may have two flags at the beginning and end of the audio signal to identify to the AMA-VQT 300 the beginning and the end of the sample. The AMA-VQT 300 then determines the PESQ (and possibly the MOS-LQO) voice quality score and it is automatically announced back to the CPE 304.

Those skilled in the art would appreciate, that other measurements may also be determined and reported by the AMA-VQT 300 without departing from the spirit of the present invention. Other example measurements may include time-delay, signal loss, bi-direction voice quality, etc. In another example of an implementation, a CPE and AMA-VQT may be with the same device with a loop back of the voice signal occurring with the network.

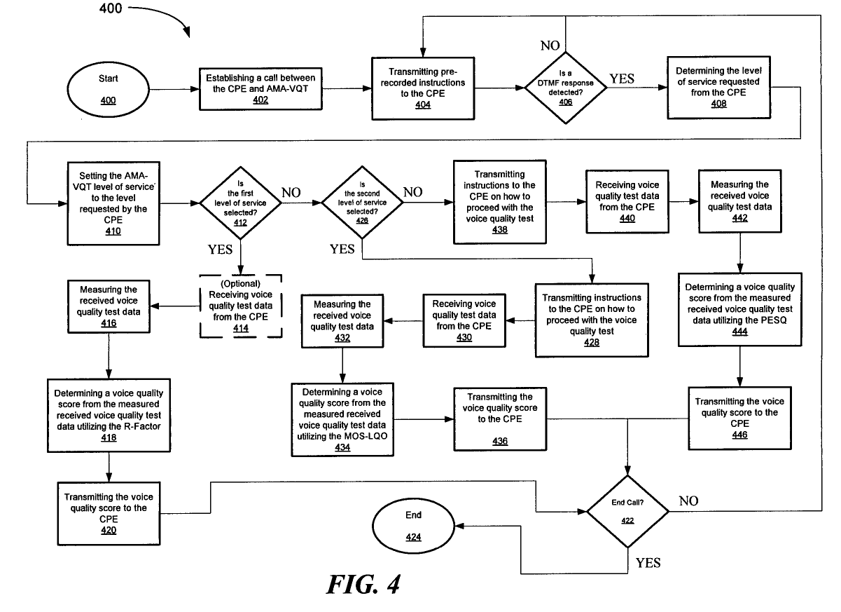

FIG. 4 is a flowchart illustrating an example of a process preformed by the AMA-VQT 300 in measuring the voice quality through the Network under Test 302 as shown in FIG. 3. The process begins in step 400 and continues to step 402. In step 402, the AMA-VQT 300 receives a call from the CPE 304 and the Communication Module 306 establishes a communication link (i.e., a “call”) with the CPE 304. The Instruction Announcement and DTMF Input Recognition Module 310 then transmits instructions to the CPE 304, via the communication module 306, on how to proceed with the measurement test in step 404.

In decision step 406, the Instruction Announcement and DTMF Input Recognition Module 310 waits to detect a DTMF response (such as a tone corresponding to the “1” key being pressed) from the CPE 304. If a DTMF response is not detected, the process returns to step 404 and the Instruction Announcement and DTMF Input Recognition Module 310 again transmits instructions to the CPE 304, via the communication module 306, on how to proceed with the measurement test in step 404.

If, instead, a DTMF response is detected, the process continues to step 408 where the Authorization Module 308 determines the type of service requested from the CPE 304 and, in step 410, instructs the Voice Quality Measurement Module 314 which service level module to use based on the type of service requested from the CPE 304. It is appreciated by those skilled in the art that Authorization Module 308 may determine the type of service requested from the CPE 304 by receiving a password from the CPE 304 that corresponds to the particular type of service that the CPE 304 is subscribed to receive.

The process then continues to decision step 412, which directs the AMA-VQT 300 to use the R-Factor method in determining the voice quality score if the Authorization Module 308 determined that the type of service requested from the CPE 304 is a first service level.

If the first service level was selected by the CPE 304, the process continues to optional step 414, where the AMA-VQT 300 receives the voice quality test data from the CPE 304 and passes it to the Voice Quality Measurement Module 314. The voice quality test data may be DTMF responses from the CPE 304 in response to the instructions from the Instruction Announcement and DTMF Input Recognition Module 310 in step 404 or a subsequent optional step (not shown). Step 414 is optional because the CPE 304 has already responded with a DTMF response in step 406 and this DTMF response may be sufficient for the purpose of measuring the voice quality score when utilizing the R-Factor method at the first service level.

As an example, optional step 414 would allow the Instruction Announcement and DTMF Input Recognition Module 310 to instruct the CPE 304 to provide some voice samples to the AMA-VQT 300 either by having a user speak into the CPE 304 for a predetermined time period (such as 10 seconds) or by having the CPE 304 use a pre-recorded voice sample or data audio sample (such as a combination of test tones) in the case that the CPE 304 includes an audio device.

In step 414, the AMA-VQT 300 would receive this voice quality test data from the CPE 304 and pass it to the Voice Quality Measurement Module 314. The process then continues to step 416, where the Voice Quality Measurement Module 314 measures the voice quality of the received DTMF response, voice sample, pre-recorded voice and/or data audio sample from the CPE 304 and, in step 418, determines the voice quality score utilizing the R-Factor module 318. In step 420, the Voice Quality Measurement Module 314 passes the determined voice quality score to the Voice Composing and Announcement Module 416 which transmits the voice quality score to the CPE 304, via the Communication Module 306, and the process continues to decision step 422.

In decision step 422, the AMA-VQT 300 determines if the CPE 304 desires to end the call. If the CPE 304 instructs the AMA-VQT 300 to continue the test, the process returns to step 404, where the Instruction Announcement and DTMF Input Recognition Module 310 then transmits instructions to the CPE 304, via the communication module 306, on how to proceed with the measurement test in step 404. If, instead, the CPE 304 instructs the AMA-VQT 300 to discontinue the test the process ends in step 424.

As an example of the messages passed in Step 420, the Voice Composing and Announcement Module 416 may compose voice messages that state: (a) “Your R-Factor value is XXX, therefore your voice quality is such that users are very satisfied,” if the R-Factor generated voice quality score is between 90-100; (b) “Your R-Factor value is XXX, therefore your voice quality is such that users are satisfied,” if the R-Factor generated voice quality score is between 80-89; (c) “Your R-Factor value is XXX, therefore your voice quality is such that some users are dissatisfied,” if the R-Factor generated voice quality score is between 70-79; (d) “Your R-Factor value is XXX, therefore your voice quality is such that many users are dissatisfied,” if the R-Factor generated voice quality score is between 60-69; and (e) “Your R-Factor value is XXX, therefore your voice quality is such that nearly all users are dissatisfied,” if the R-Factor generated voice quality score is between 50-59. Where it is appreciated that the variable “XXX” stands for the value of the R-Factor.

If the first level of service was not selected by the CPE 304, the process continues to decision step 426, which directs the AMA-VQT 300 to use the MOS-LQO method in determining the voice quality score if the Authorization Module 308 determined that the type of service requested from the CPE 304 is a second service level.

If the second level of service was selected by the CPE 304, the process continues to step 428. In step 428, the Instruction Announcement and DTMF Input Recognition Module 310 transmits new instructions to the CPE 304, via the communication module 306, on how to proceed with the measurement test. The Instruction Announcement and DTMF Input Recognition Module 310 may instruct the CPE 304 to provide some voice samples to the AMA-VQT 300 either by having a user speak into the CPE 304 for a predetermined time period (such as 10 seconds) or by having the CPE 304 use a pre-recorded voice sample or data audio sample (such as a combination of test tones) in the case that the CPE 304 includes an audio device.

In step 430, the AMA-VQT 300 receives this voice quality test data from the CPE 304 and passes it to the Voice Quality Measurement Module 314. The process then continues to step 432, where the Voice Quality Measurement Module 314 measures the voice quality of the received voice sample, pre-recorded voice sample, or data audio sample from the CPE 304. In step 434, the Voice Quality Measurement Module 314 determines the voice quality score utilizing the MOS-LQO module 330. In step 436, the Voice Quality Measurement Module 314 passes the determined voice quality score to the Voice Composing and Announcement Module 416, which transmits the voice quality score to the CPE 304, via the Communication Module 306, and the process continues to decision step 422.

In decision step 422, the AMA-VQT 300 determines if the CPE 304 desires to end the call. If the CPE 304 instructs the AMA-VQT 300 to continue the test the process returns to step 404, where the Instruction Announcement and DTMF Input Recognition Module 310 then transmits instructions to the CPE 304, via the communication module 306, on how to proceed with the measurement test in step 404. If, instead, the CPE 304 instructs the AMA-VQT 300 to discontinue the test, the process ends in step 424.

As an example of the messages passed in Step 436, the Voice Composing and Announcement Module 416 may compose voice messages that state: (a) “Your MOS-LQO value is XXX, therefore your voice quality is excellent,” if the MOS-LQO generated voice quality score is 5.0 or above (typically 5.0 is the maximum value of MOS-LQO); (b) “Your MOS-LQO value is XXX, therefore your voice quality is good,” if the MOS-LQO generated voice quality score is between 4.0-4.9; (c) “Your MOS-LQO value is XXX, therefore your voice quality is fair,” if the MOS-LQO generated voice quality score is between 3.0-3.9; (d) “Your MOS-LQO value is XXX, therefore your voice quality is poor,” if the MOS-LQO generated voice quality score is between 2.0-2.9; and (e) “Your MOS-LQO value is XXX, therefore your voice quality is bad,” if the MOS-LQO generated voice quality score is between 1.0-1.9. Where it is appreciated that the variable “XXX” stands for the value of the MOS-LQO.

If the second level of service was not selected by the CPE 304, the process continues instead to step 438 because the CPE 304 has selected the third level of service. Therefore, the process directs the AMA-VQT 300 to use the PESQ method in determining the voice quality score.

In step 438, the Instruction Announcement and DTMF Input Recognition Module 310 transmits new instructions to the CPE 304, via the communication module 306, on how to proceed with the measurement test. The Instruction Announcement and DTMF Input Recognition Module 310 may instruct the CPE 304 to provide some pre-recorded voice or data audio samples to the AMA-VQT 300 by having the CPE 304 use a pre-recorded voice sample or data audio sample. Unlike the R-Factor and MOS-LQO type methods, the PESQ method requires the CPE 304 to include an audio device (such as a cassette player or digital audio device) because the PESQ score is based on the original and degraded voice or data audio samples. Therefore, in the PESQ method, the original voice or data audio samples should be known to the AMA-VQT 300, and the CPE 304 should use a pre-recorded copy of the particular voice or data audio sample that is known to the AMA-VQT 300. In step 440, the AMA-VQT 300 then receives this voice quality test data from the CPE 304 and passes it to the Voice Quality Measurement Module 314. The process then continues to step 442, where the Voice Quality Measurement Module 314 measures the voice quality of the pre-recorded voice sample or data audio sample from the CPE 304 and, in step 444, determines the voice quality score utilizing the PESQ module 322. In step 446, the Voice Quality Measurement Module 314 passes the determined voice quality score to the Voice Composing and Announcement Module 416, which transmits the voice quality score to the CPE 304, via the Communication Module 306, and the process continues to decision step 422.

In decision step 422, the AMA-VQT 300 determines if the CPE 304 desires to end the call. If the CPE 304 instructs the AMA-VQT 300 to continue the test the process returns to step 404, where the Instruction Announcement and DTMF Input Recognition Module 310 then transmits instructions to the CPE 304, via the communication module 306, on how to proceed with the measurement test in step 404. If, instead, the CPE 304 instructs the AMA-VQT 300 to discontinue the test the process ends in step 424.

As an example of the messages passed in step 446, the Voice Composing and Announcement Module 416 may compose voice messages that state: (a) “Your PESQ value is XXX, therefore your voice quality is good,” if the PESQ generated voice quality score is between 4.0-4.5 (typically 4.5 is the maximum for PESQ); (b) “Your PESQ value is XXX, therefore your voice quality is fair,” if the PESQ generated voice quality score is between 3.0-3.9; (c) “Your PESQ value is XXX, therefore your voice quality is poor,” if the PESQ generated voice quality score is between 1.0-2.9; and (d) “Your PESQ value is XXX, therefore your voice quality is bad,” if the PESQ generated voice quality score is between −0.5-0.9. Where it is appreciated that the variable “XXX” stands for the value of the PESQ.

Persons skilled in the art will understand and appreciate, that one or more processes, sub-processes, or process steps described in connection with FIG. 4 may be performed by hardware and/or software. Additionally, the AMA-VQT 300 may be implemented completely in software that would be executed within a microprocessor, general purpose processor, combination of processors, digital signal processor (“DSP”), and/or application specific integrated circuit (“ASIC”). If the process is performed by software, the software may reside in software memory (not shown) in the AMA-VQT 300. The software in software memory may include an ordered listing of executable instructions for implementing logical functions (i.e., “logic” that may be implemented either in digital form such as digital circuitry or source code or in analog form such as analog circuitry or an analog source such an analog electrical, sound or video signal), and may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

While the foregoing description refers to the use of an Automatic Measurement and Announcement Voice Quality Test System, the subject matter is not limited to such a system. Any Voice Quality Testing system that could benefit from the functionality provided by the components described above may be implemented in the Automatic Measurement and Announcement Voice Quality Test System 200.

Moreover, it will be understood that the foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed:

1. An Automatic Measurement and Announcement Voice Quality Tester (“AMA-VQT”) for measuring the voice quality of a communication link from a customer premises equipment (“CPE”) through a Network under Test to the AMA-VQT, the AMA-VQT comprising:
a Communication Module in signal communication with the CPE through the communication link;
an Authorization Module in signal communication with the Communication Module;
an Instruction Announcement and Dual Tone Multiple Frequency (“DTMF”) Input Recognition Module in signal communication with the Communication Module and the Authorization Module;
a Voice Composing and Announcement Module in signal communication with the Communication Module; and
a Voice Quality Measurement Module in signal communication with the Authorization Module, Instruction Announcement and DTMF Input Recognition Module, and Voice Composing and Announcement Module, wherein the Voice Quality Measurement Module is adapted to measure the voice quality of the communication link.

2. The AMA-VQT of claim 1, wherein the Communication Module is adapted to establish the communication link with the CPE.

3. The AMA-VQT of claim 2, wherein the Instruction Announcement and DTMF Input Recognition Module is adapted to:
transmit instructions to the CPE,
receive DTMF signals from the CPE,
decode the DTMF signals, and
respond to the CPE with corresponding commands in response to receiving the DTMF signals

4. The AMA-VQT of claim 3, wherein the Voice Quality Measurement Module calculates a voice quality score that corresponds to the voice quality of the communication link, wherein the voice quality score is determined by utilizing a service level module chosen from the group consisting of:
a service level module that utilizes an Rating Factor (“R-factor”) test to determine the voice quality score,
a service level module that utilizes a Mean Opinion Score—Listening Quality Objective (“MOS-LQO”) test to determine the voice quality score, and
a service level module that utilizes a Perceptual Evaluation of Speech Quality (“PESQ”) test to determine the voice quality score.

5. The AMA-VQT of claim 4, wherein the Voice Composing and Announcement Module is adapted to:
compose an announcement message that corresponds to the voice quality score utilizing a prerecorded voice database, and
transmit the announcement message to the CPE.

6. The AMA-VQT of claim 5, wherein the Authorization Module is adapted to determine the service level module from authorization data received from the CPE.

7. The AMA-VQT of claim 6, further including a Logging and Database Maintenance Module is adapted to:
log in data from the CPE, Communication Module, Authorization Module, Instruction Announcement and DTMF Input Recognition Module, Instruction Announcement and DTMF Input Recognition Module, Voice Composing and Announcement Module, and Voice Quality Measurement Module, and
maintain the data in a database.

8. The AMA-VQT of claim 7, wherein the CPE is an Internet Protocol (“IP”) communication device.

9. A method for measuring the voice quality of a communication link from a customer premises equipment (“CPE”) through a Network under Test to the AMA-VQT, the method comprising:
transmitting instructions to the CPE;
receiving voice quality test data from the CPE in response to the transmitted instructions;
measuring the received voice quality test data;
determining a voice quality score from the received voice quality test data; and
transmitting the voice quality score to the CPE.

10. The method of claim 9, further including:
establishing the communication link between the CPE and AMA-VQT, and
determining a level of service requested from the CPE in response to the transmitted instructions.

11. The method of claim 10, wherein the voice quality score is determined by utilizing the level of service where the level of service is chosen from the group consisting of
a first level of service utilizing an Rating Factor (“R-factor”) test to determine the voice quality score,
a second level of service utilizing Mean Opinion Score—Listening Quality Objective (“MOS-LQO”) test to determine the voice quality score, and
a third level of service utilizing Perceptual Evaluation of Speech Quality (“PESQ”) test to determine the voice quality score.

12. The method of claim 11, further including determining the level of service from authorization data received from the CPE.

13. The method of claim 12, wherein transmitting instructions to the CPE includes:
transmitting instructions to the CPE,
receiving Dual Tone Multiple Frequency (“DTMF”) signals from the CPE,
decoding the DTMF signals, and
responding to the CPE with corresponding commands.

14. The method of claim 13, further including:
composing an announcement message corresponding to the voice quality score utilizing a prerecorded voice database, and
playing the announcement message to the CPE.

15. The method of claim 14, further including:
logging data from the CPE, Communication Module, Authorization Module, Instruction Announcement and DTMF Input Recognition Module, Instruction Announcement and DTMF Input Recognition Module, Voice Composing and Announcement Module, and Voice Quality Measurement Module, and
maintaining the data in a database.

16. A signal-bearing medium having software for measuring the voice quality of a communication link from a customer premises equipment (“CPE”) through a Network under Test to the AMA-VQT, the signal-bearing medium comprising:
logic configured for establishing the communication link between the CPE and AMA-VQT,
logic configured for transmitting instructions to the CPE;
logic configured for receiving voice quality test data from the CPE in response to the transmitted instructions;
logic configured for determining a level of service requested from the CPE in response to the transmitted instructions;
logic configured for measuring the received voice quality test data;
logic configured for determining a voice quality score from the received voice quality test data; and
logic configured for transmitting the voice quality score to the CPE.

17. The signal-bearing medium of claim 16, wherein the voice quality score is determined by utilizing the level of service where the level of service is chosen from the group consisting of
a first level of service utilizing an Rating Factor (“R-factor”) test to determine the voice quality score,
a second level of service utilizing Mean Opinion Score—Listening Quality Objective (“MOS-LQO”) test to determine the voice quality score, and
a third level of service utilizing Perceptual Evaluation of Speech Quality (“PESQ”) test to determine the voice quality score.

18. The signal-bearing medium of claim 17, further including logic configured for determining the level of service from authorization data received from the CPE.

19. The signal-bearing medium of claim 18, further including:
logic configured for composing an announcement message corresponding to the voice quality score utilizing a prerecorded voice database, and
logic configured for playing the announcement message to the CPE.

20. The signal-bearing medium of claim 15, further including:
logic configured for logging data from the CPE, Communication Module, Authorization Module, Instruction Announcement and Dual Tone Multiple Frequency (“DTMF”) Input Recognition Module, Instruction Announcement and DTMF Input Recognition Module, Voice Composing and Announcement Module, and Voice Quality Measurement Module, and
logic configured for maintaining the data in a database.
